(19) United States
(12) Patent Application Publication
(10) Pub. No.: US 2023/0142483 A1
(43) Pub. Date: May 11, 2023

(54) NOVEL POLYAMIDE

(71) Applicant: SOLVAY SPECIALTY POLYMERS USA, LLC, Alpharetta, GA (US)

(72) Inventors: Tanner Gerschick, Roswell, GA (US); Nancy J. Singletary, Alpharetta, GA (US); Anthony Bocahut, Milano (IT); Marie-Laure Michon, Villeurbanne (FR); Joel Pollino, Johns Creek, GA (US)

(73) Assignee: SOLVAY SPECIALTY POLYMERS USA, LLC, Alpharetta, GA (US)

(21) Appl. No.: 17/802,875

(22) PCT Filed: Feb. 23, 2021
(86) PCT No.: PCT/EP2021/054387

§ 371 Date: Aug. 26, 2022

(30) Foreign Application Priority Data
Feb. 28, 2020 (EP) 20315025.5

(51) Int. Cl. C08G 69/24

(52) U.S. Cl. CPC C08G 69/24

(57) ABSTRACT

The present invention relates to a novel polyamide polymer, to a process for its manufacture and to the use thereof for the manufacture of thermoplastic composites, and articles manufactured via injection molding, extrusion and through additive manufacturing technologies.

### CROSS-REFERENCE TO RELATED APPLICATIONS

This application claims priority to European application No. 20315025.5 filed on Feb. 28, 2020, the whole content of this application being incorporated herein by reference for all purposes.

### TECHNICAL FIELD

The present invention relates to a novel polyamide polymer, to a process for its manufacture and to the use thereof for the manufacture of thermoplastic composites, and articles manufactured via injection molding, extrusion and through additive manufacturing technologies.

### BACKGROUND ART

Synthetic linear polyamides are generally prepared by condensation of substantially equimolar amounts of a diamine and a carboxylic acid, or its amide-forming derivatives or by the self-condensation of a relatively long chain amino acids or their amido-forming derivatives.

The mechanical properties of polyamides depend on their molecular weight and the constitution of their monomers, i.e. the selection of diamines and diacids.

U.S. Pat. No. 2,952,667 (Eastman Kodak Company, Rochester, N.Y.) discloses polyamides from 4-carboxy-piperidine (isonipecotic acid) and the preparation of these resinous materials. More in particular, the 4-carboxypiperidine was found capable of (I) self-condensing thus making homopolyamides and (II) co-condensing with various aminoacids or salts of dicarboxylic acids and diamines, in the proportion of at least 50 mole percent of the 4-carboxypiperidine component, the advantageous range being from 50-95 mole percent. U.S. Pat. No. 3,297,655 (Francis E. Cislak) discloses polyamides characterized by recurring units of formula:

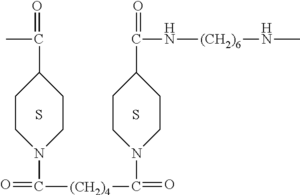

which are manufactured by reacting a bis-carboxypiperidine with a diamine. This reaction allows synthesis of polyamide polymers having a strictly alternating recurring units.

U.S. Pat. No. 3,371,068 (Monsanto Company) discloses synthetic linear condensation polyamides obtained from the reaction of dipiperidyls with dicarboxylic acid chlorides. These polyamides contain recurring structural units of formula:

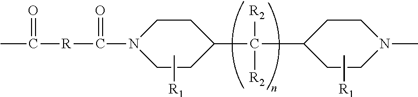

wherein n is an integer from 0 to 5 and R2 represent hydrogen or methyl.

More recently, WO 2019/121823 (Rhodia Operations) disclosed piperidine-containing semi-aromatic polyamide, comprising structural unit derived from piperidine and an aromatic diacid, having the following general formula (1):

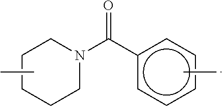

The semi-aromatic polyamide is obtained by polymerization of a diamine of formula (3):

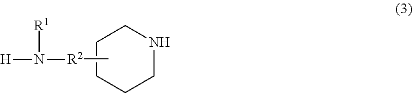

with an aromatic dicarboxylic acid or ester of formula (4):

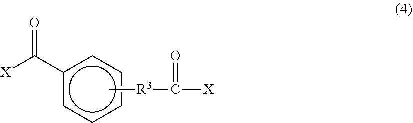

The same structural unit of formula (1) above was also disclosed in WO 2019/12182 and WO 2019/121826 (both in the name of Rhodia Operations). The above mentioned patent applications neither disclose nor exemplify co-polyamides obtained using the isonipecotic acid as co-monomer.

### SUMMARY OF INVENTION

Despite the large number of known polyamides, the Applicant perceived that there is still need for further improving the overall properties of these polymers.

Indeed, the Applicant faced the problem of providing a new polyamide characterized by good flow and processing properties, without negatively affecting its mechanical properties.

Thus, in a first aspect, the present invention relates to a polymer [polymer (PA)] comprising:
less than 50 mol. % relative to the total number of moles of recurring units in polymer (PA) of recurring units comprising a piperidine ring and complying with formula [R_{INP}]:

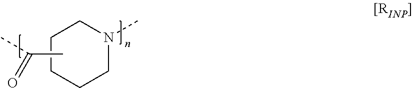

at least one recurring unit [R_{PA}] selected from:

[R_{PA}(I)]—[R_{PA}(II)] [symbol] [HN-G^{I}-NH]—[(O═)C-G^{II}-C(═O)]

[symbol]

[R_{PA}(III)] [symbol] [HN-G^{III}-C(═O)]

[symbol]

wherein:

each of G^{I}, G^{II} and G^{III} is an optionally substituted linear or branched alkyl chain comprising from 1 to 16 carbon atoms, an optionally substituted cycloalkyl group comprising 6 carbon atoms, or an optionally substituted phenylene; wherein said recurring units [R_{INP}] and [R_{PA}] are randomly disposed along the backbone of said polymer (PA) and the sum of the number of moles of recurring units [R_{INP}] and [R_{PA}] is 100%.

Advantageously, polymer (PA) comprises said at least one recurring unit [R_{PA}] in an amount of 50 mol. % or higher, based on the total number of moles of recurring units [R_{INP}] and [R_{PA}].

According to one preferred embodiment, said —C(═O)— group is in position 3 of the piperidine ring in formula [R_{INP}] above.

According to one preferred embodiment, said —C(═O)— group is in position 4 of the piperidine ring in formula [R_{INP}] above.

### DRAWINGS

FIG. 1 is a graph representing the melt viscosity as a function of the temperature for Sample 7 and Comparative Sample 8(C), as obtained by parallel plate Dynamic Mechanical Analysis.

### DESCRIPTION OF EMBODIMENTS

As used in the present description and in the following claims:

the dashed bond(s) [ [symbol] ] in the chemical formulae represent(s) a bond to an atom outside the drawn unit.

Advantageously, polymer (PA) comprises up to 49 mol. %, preferably up to 48 mol. %, more preferably up to 47 mol. % and even more preferably up to 45 mol. % of said recurring units [R_{INP}], the amount being relative to the total number of moles of recurring units in said polymer (PA).

Advantageously, polymer (PA) comprises at least 0.5 mol. %, preferably at least 1 mol. %, more preferably at least 1.5 mol. % and even more preferably at least 2 mol. % of said recurring units [R_{INP}], the amount being relative to the total number of moles of recurring units in said polymer (PA).

Advantageously, the polymer (PA) comprises from 2 to 45 mol. %, preferably from 5 to 40 mol. %, more preferably from 10 to 30 mol. % of said recurring units [R_{INP}], the amount being relative to the total number of moles of recurring units in said polymer (PA).

Advantageously, polymer (PA) comprises at least 51 mol. %, preferably at least 52 mol. %, more preferably at least 53 mol. % and even more preferably at least 55 mol. % of said at least one recurring unit [R_{PA}], the amount being relative to the total number of moles of recurring units in said polymer (PA).

Advantageously, polymer (PA) comprises up to 99.5 mol. %, preferably up to 99 mol. %, more preferably up to 98.5 mol. % and even more preferably up to 98 mol. % of said at least one recurring unit [R_{PA}], the amount being relative to the total number of moles of recurring units in said polymer (PA).

Advantageously, polymer (PA) comprises from 55 to 98 mol. %, preferably from 60 to 95 mol. %, more preferably from 70 to 90 mol. % of said at least one recurring unit [R_{PA}], the amount being relative to the total number of moles of recurring units in said polymer (PA).

Preferably, when said polymer (PA) comprises recurring unit [R_{PA}] complying with formula

[R_{PA}(I)]—[R_{PA}(II)] [symbol] [HN-G^{I}-NH]—[(O═)C-G^{II}-C(═O)] [symbol] ,

said [R_{PA}(I)] [symbol] [HN-G^{I}-NH]—* and

[R_{PA}(II)]—(═O)C-G^{II}-C(═O)

[symbol]

are in a substantially equimolar amount, with * indicating the bond between the nitrogen atom of [R_{PA}(I)] and the carbon atom of [R_{PA}(II)].

Preferably, said [R_{PA}(I)] is selected from the group comprising at least one divalent moiety complying with any of the following formulae, with * indicating the bond between the nitrogen atom of [R_{PA}(I)] and the carbon atom of [R_{PA}(II)]: (I-a)

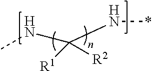

wherein

n is an integer from 1 to 20, preferably from 2 to 15, more preferably from 3 to 12,

R¹ and R² are independently selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium;

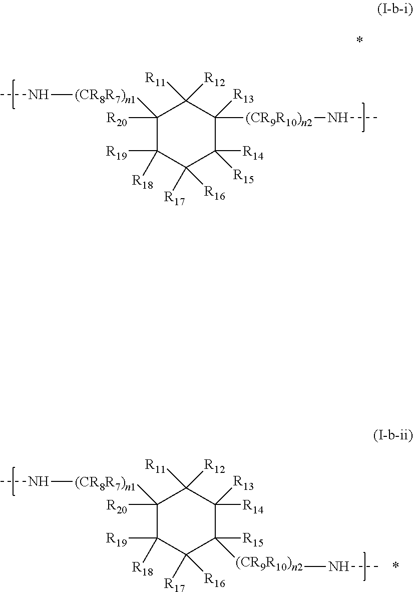

wherein

each of R₇ to R₂₀ is independently selected from hydrogen atom, halogen atom, alkyl, alkenyl, alkynyl, aryl, cycloalkyl, cycloaryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,

each of n1 and n2, independently, is 0 or an integer from 1 to 20, preferably from 2 to 15, more preferably from 3 to 12;

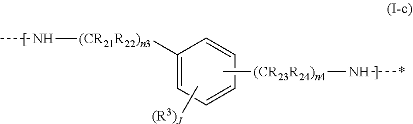

wherein

R³ is selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium,

J is 0 or an integer from 1 to 4,

each of R₂₁ to R₂₄ is independently selected from hydrogen atom, halogen atom, alkyl, alkenyl, alkynyl, aryl, cycloalkyl, cycloaryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium, each of n3 and n4, independently, is 0 or an integer from 1 to 20, preferably from 2 to 15, more preferably from 3 to 12; (I-d)

[symbol]

{NH—(CR₂₅R₂₆CR₂₇R₂₈)ₙ₅—[(CR₂₉R₃₀CR₃₁R₃₂O)ₙ₆]ₘ₁—(CR₃₃R₃₄CR₃₅R₃₆)ₙ₇—NH} [symbol] *

wherein

each of R₂₅ to R₃₆ is independently selected from hydrogen atom or alkyl chain having from 1 to 3 carbon atoms,

each of n5, n6, m1 and n7 is independently 0 or an integer from 1 to 12, and the recurring units having n5, n6, m1 and n7 are randomly disposed;

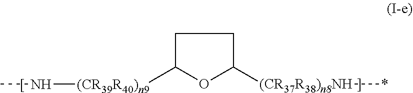

wherein

each of R₃₇ to R₄₀ is independently selected from hydrogen atom or alkyl chain having from 1 to 3 carbon atoms,

each of n8 and n9 is independently 0 or an integer from 1 to 12.

Preferably, said at least one recurring unit [R_{PA}(I)] of formula (I-a) is selected from the group comprising the following formula, with * indicating the bond between the nitrogen atom of [R_{PA}(I)] and the carbon atom of [R_{PA}(II)]:

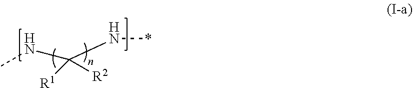

wherein

n is an integer from 1 to 12 and

each of R¹ and R² is independently hydrogen atom or linear or branched alkyl chain having from 1 to 6 carbon atoms, more preferably methyl group.

Preferably, said at least one recurring unit [R_{PA}(I)] of formula (I-b-i) or (I-b-ii) is selected from the group comprising the following formulae, with * indicating the bond between the nitrogen atom of [R_{PA}(I)] and the carbon atom of [R_{PA}(II)]:

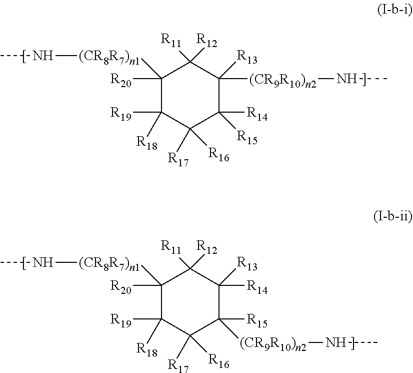

wherein

each of n1 and n2 is independently 0 or 1,

each of R₇ to R₁₀ when present is independently hydrogen atom or linear or branched alkyl chain having from 1 to 6 carbon atoms, more preferably methyl group;

each of R₁₁ to R₂₀ is independently hydrogen or linear or branched alkyl chain having from 1 to 6 carbon atoms, more preferably methyl group.

Preferably, said at least one recurring unit [R_{PA}(I)] of formula (I-c) is selected from the group comprising the following formula, with * indicating the bond between the nitrogen atom of [R_{PA}(I)] and the carbon atom of [R_{PA}(II)]:

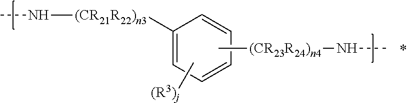

wherein

each of n3 and n4 independently is 0 or 1;

each of R₂₁ to R₂₄, when present, is independently hydrogen atom or linear or branched alkyl chain having from 1 to 6 carbon atoms, more preferably methyl group,

J is preferably 0 or 1; and

R³ when present is a linear or branched alkyl chain having from 1 to 6 carbon atoms, more preferably methyl group.

Preferably, said [R_{PA}(II)] is selected from the group comprising at least one divalent moiety complying with any of the following formulae, with * indicating the bond between the nitrogen atom of [R_{PA}(I)] and the carbon atom of [R_{PA}(II)]:

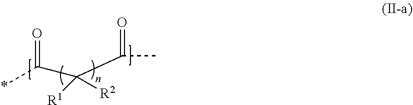

wherein

n, R¹ and R² have the meanings defined above for formula (I-a);

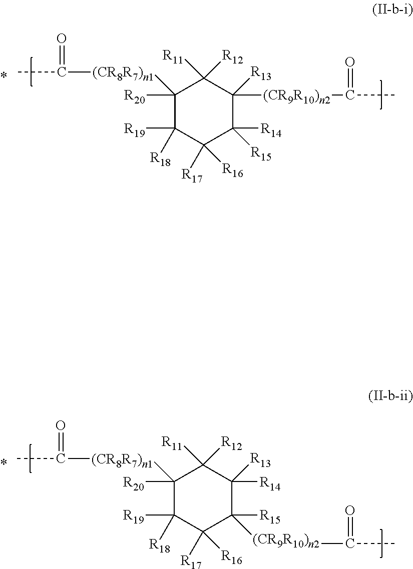

wherein

each of R₇ to R₂₀, n1 and n2 has the meanings defined above for formulae (I-b-i) and (I-b-ii);

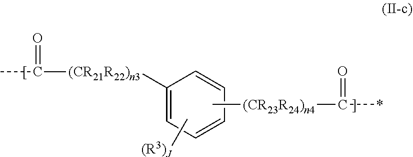

wherein

each of R³, J, n3, n4 and R₂₁ to R₂₄ has the meanings defined above for formula (I-c);

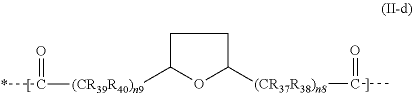

wherein each of R₃₇ to R₄₀, n8 and n9 has the meanings defined above for formula (I-e).

Preferably, said at least one recurring unit [R_{PA}(II)] of formula (II-a) is selected from the group comprising the following formula, with * indicating the bond between the nitrogen atom of [R_{PA}(I)] and the carbon atom of [R_{PA}(II)]:

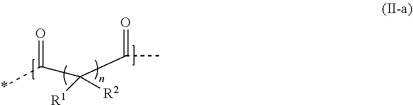

wherein n is an integer from 1 to 12 and

each of R¹ and R² is independently hydrogen atom or linear or branched alkyl chain having from 1 to 6 carbon atoms, more preferably methyl group.

Preferably, said at least one recurring unit [R_{PA}(II)] of formula (II-b-i) or (II-b-ii) is selected from the group comprising the following formulae, with * indicating the bond between the nitrogen atom of [R_{PA}(I)] and the carbon atom of [R_{PA}(II)]:

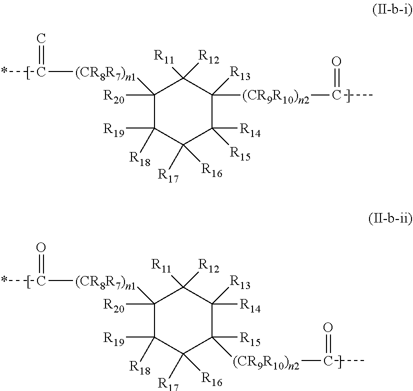

wherein

each of n1 and n2 is independently 0 or 1,

each of R₇ to R₁₀ when present is independently hydrogen atom or linear or branched alkyl chain having from 1 to 6 carbon atoms, more preferably methyl group;

each of R₁₁ to R₂₀ is independently hydrogen or linear or branched alkyl chain having from 1 to 6 carbon atoms, more preferably methyl group.

Preferably, said at least one recurring unit [R_{PA}(II)] of formula (II-c) is selected from the group comprising the following formula, with * indicating the bond between the nitrogen atom of [R_{PA}(I)] and the carbon atom of [R_{PA}(II)]:

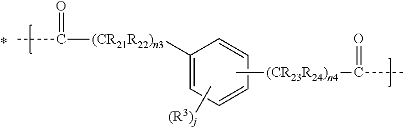

wherein

each of n3 and n4 independently is 0 or 1;

each of R₂₁ to R₂₄, when present, is independently hydrogen atom or linear or branched alkyl chain having from 1 to 6 carbon atoms, more preferably methyl group,

J is preferably 0 or 1; and

R³ when present is linear or branched alkyl chain having from 1 to 6 carbon atoms, more preferably methyl group.

Preferably, said recurring unit of formula [R_{PA}(III)] is selected from the group comprising at least one divalent moiety complying with the following formulae:

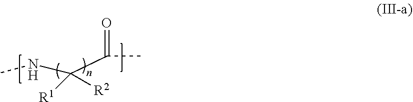

wherein

n, R¹ and R² have the meanings defined above for formula (I-a);

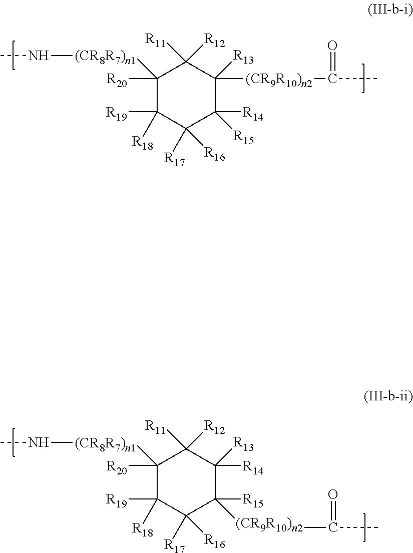

wherein

each of n1, n2 and R₇ to R₂₀ has the meanings defined above for formulae (I-b-i) and (I-b-ii);

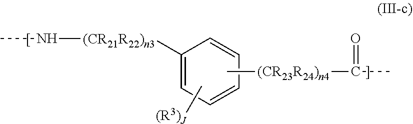

wherein

each of R³, J, n3, n4 and R₂₁ to R₂₄ has the meanings defined above for formula (I-c).

Preferably, said at least one recurring unit [R_{PA}(III)] of formula (III-a) is selected from the group comprising:

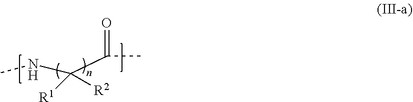

wherein

n is an integer from 1 to 12 and

each of R¹ and R² is independently hydrogen atom or linear or branched alkyl chain having from 1 to 6 carbon atoms, more preferably methyl.

Preferably, said at least one recurring unit [R_{PA}(III)] of formula (III-b-i) or (III-b-ii) is selected from the group comprising:

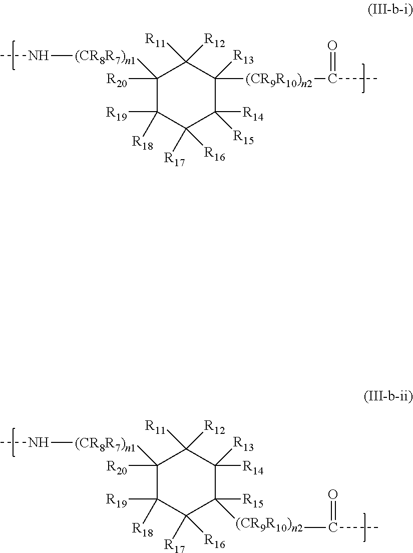

wherein

each of n1 and n2 is independently 0 or 1,

each of R₇ to R₁₀ when present is independently hydrogen atom or linear or branched alkyl chain having from 1 to 6 carbon atoms, more preferably methyl group;

each of R₁₁ to R₂₀ is independently hydrogen or linear or branched alkyl chain having from 1 to 6 carbon atoms, more preferably methyl group.

Preferably, said at least one recurring unit [R_{PA}(III)] of formula (III-c) is selected from the group comprising:

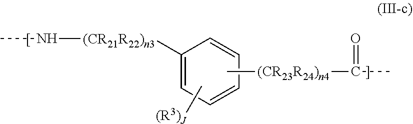

wherein

each of n3 and n4 independently is 0 or 1;

each of R₂₁ to R₂₄, when present, is independently hydrogen atom or linear or branched alkyl chain having from 1 to 6 carbon atoms, more preferably methyl group,

J is preferably 0 or 1; and

R³ when present is linear or branched alkyl chain having from 1 to 6 carbon atoms, more preferably methyl group.

According to a preferred embodiment, said polymer (PA) comprises less than 50 mol. % of said recurring unit [R_{INP}] and more than 50 mol. % of at least two recurring units [R_{PA}].

According to this embodiment, said at least two recurring units [R_{PA}] are selected from recurring units of formula (I-a) and (I l-c) as defined above and mixtures thereof, or (I-c) and (II-a) as defined above and mixtures thereof.

According to a more preferred embodiment, the polymer (PA) of the invention comprises:
from 2 mol. % to 48 mol. % of at least one recurring unit [R_{PA}] of formula (I-a) and/or (I-c) and
from 2 mol. % to 48 mol. % of at least one recurring unit [R_{PA}] of formula (II-a) and/or (I l-c),

such that the total molar amount of said recurring units is at least 50 mol. % based on 100 mol. % of said polymer (PA).

The molecular weight of the polymer (PA) is not particularly limited and can be preferably selected by the person skilled in the art depending on the final application for which the polymer (PA) is intended.

Preferably, however, the number average molecular weight of the polymer (PA) of the invention is at least 5000, as measured by gel permeation chromatography, as detailed in the experimental section.

Advantageously, the polymer (PA) of the present invention shows a glass transition temperature (Tg) below 200° C., as determined by DSC analysis, as detailed in the experimental section.

Advantageously, the polymer (PA) of the present invention shows a polydispersity (PD) in the range from 1.5 to 5.0.

Advantageously, the polymer (PA) of the invention comprises recurring units [R_{INP}] deriving from nipecotic acid.

Preferably, said recurring units [R_{PA}] complying with formula (I-a) derive from a reactant selected in the group comprising, more preferably consisting of: 1,2-diaminoethane, 1,3-diaminopropane, 1,3-diaminobutane, 1,4-diaminobutane, 1,5-diaminopentane, 1,6-diaminohexane (also referred to as hexamethylendiamine—HDM), 2-methyl pentamethylene diamine, 2-methyl hexamethylene diamine, 3-methyl hexamethylene diamine, 2,5-dimethyl hexamethylene diamine, 2,2-dimethyl pentamethylene diamine, 1,8-diamino octane, methyl-1,8-diamino octane, 2-methyloctane diamine, 1,9-diamino nonane, 5-methylnonane diamine, 1,10-diamino decane (also referred to as decamethylene diamine) 1,12-diamino dodecane (also referred to as dodecamethylene diamine), 2,2,4-trimethyl hexamethylene diamine, 2,4,4-trimethyl hexamethylene diamine, 2,2,7,7-tetramethyl octamethylene diamine, and mixtures thereof.

Preferably, said recurring units [R_{PA}] complying with formula (I-b-i) or (I-b-ii) derive from a reactant selected in the group comprising, more preferably consisting of: 1,3-diaminocyclohexane, 1,4-diaminocyclohexane, 1,3-bis(aminomethyl)cyclohexane, 1,4-bis(aminomethyl)cyclohexane, isophoronediamine, and mixtures thereof.

Preferably, said recurring units [R_{PA}] complying with formula (I-c) derive from a reactant selected in the group comprising, more preferably consisting of: 1,4-diaminobenzene, 1,3-diaminobenzene, 1,2-diaminobenzene, m-xylylendiamine, p-xylylendiamine, and mixtures thereof.

Preferably, said recurring units [R_{PA}] complying with formula (I-d) derive from diamines commercially available from Huntsman under the tradename Jeffamine® polyetheramines.

Preferably, said recurring units [R_{PA}] complying with formula (I-e) derive from 2,5-bis(aminomethyl)tetrahydrofuran.

Preferably, said recurring units [R_{PA}] complying with formula (II-a) derive from a reactant selected in the group comprising, more preferably consisting of: oxalic acid, malonic acid, succinic acid, glutaric acid, 2-methylglutaric acid, 2,2-dimethylglutaric acid, adipic acid, 2,4,4-trimethyladipic acid, pimelic acid, suberic acid, azelaic acid, sebacic acid, undecanedioic acid, dodecanediic acid, tridecanedioic aid, tetradecanedioic acid, pentadecanedioic acid, hexadecanedioic acid, octanedioic acid, and mixtures thereof.

Preferably, said recurring units [R_{PA}] complying with formula (II-b-i) and (II-b-ii) derive from a reactant selected in the group comprising, more preferably consisting of: 1,3-cyclohexane dicarboxylic acid, 1,4-cyclohexane dicarboxylic acid, and mixtures thereof.

Preferably, said recurring units [R_{PA}] complying with formula (II-c) derive from a reactant selected in the group comprising, more preferably consisting of: isophthalic acid, terephthalic acid, orthophthalic acid, 2-hydroterephthalic acid, 5-hydroxyisophthalic acid, 4-hydroxyisophthalic acid, 2,5-dihydroxyterephthalic acid, and mixtures thereof.

Preferably, said recurring units [R_{PA}] complying with formula (III-a) derive from a reactant selected in the group comprising, more preferably consisting of: 2-amino-4-methylpentanoic acid, 6-aminohexanoic acid, 10-aminodecanoic acid, 11-aminoundecanoic acid, 12-aminoundecanoic acid.

Preferably, said recurring units [R_{PA}] complying with formula (III-c) derive from a reactant selected in the group comprising, more preferably consisting of: 3-aminomethyl benzoic acid, 4-aminomethylbenzoic acid.

In a second aspect, the present invention relates to a method for manufacturing said polymer (PA), said method comprising contacting said nipecotic acid with at least one of the reactant listed above to provide recurring units of formula [R_{PA}(I)], [R_{PA}(II)] and/or [R_{PA}(III)].

The person skilled in the art will understand that the reaction between said nipecotic acid and said at least one reactant proceeds via polycondensation reaction.

Advantageously, the reaction is performed in a solvent, which is preferably water.

Preferably, said polycondensation reaction is performed under heating, more preferably at a temperature higher than 100° C.

Preferably, said polycondensation reaction is performed at pressure higher than 0.1 MPa, more preferably higher than 0.5 MPa.

If required by the circumstances, the polymer (PA) can also comprise at least one mono-functional compound selected from mono-amines, mono-anhydrides, monoacids as chain limiters, which are preferably selected in the group comprising phthalic anhydride, 1-aminopentane, 1-aminohexane, 1-aminoheptane, 1-aminooctane, 1-aminononane, 1-aminodecane, 1-aminoundecane, 1-aminododecane, benzylamine, acetic acid, propionic acid, benzoic acid, stearic acid or mixtures thereof.

Amino End Group (AEG) of the polymer (PA) may be from 5 to 550 meq/Kg. Carboxylic End Group (CEG) of the co-polyamide may be from 5 to 550 meq/Kg. AEG and CEG may be measured by an acido-basis titration after solubilisation of the co-polyamide in a solvent. The sum of the end groups (AEG+CEG) may be comprised from 10 to 900 meq/Kg, preferably from 150 to 600 meq/Kg.

The reaction for manufacturing the polymer (PA) of the invention can be continuous or batch wise.

The present invention encompasses a polymer (PA) obtained by the method described above.

The present invention further comprises a composition [composition (C)] comprising at least the polymer (PA) of the invention, in admixture with other additional ingredients selected reinforcing fibres and additives selected from the group comprising, more preferably consisting of: UV stabilizers, heat stabilizers, pigments, dyes, flame retardants, impact modifiers, processing aids, nucleating agents, mineral fillers, and mixtures thereof.

Said reinforcing fibers are preferably selected in the group comprising carbon fibers, continuous or chopped glass fibers, synthetic polymeric fibres, aluminium fibres, aluminium silicate fibres, titanium fibres, steel fibres, silicon carbide fibres and boron fibers. Glass fibers and carbon fibers are particularly preferred.

If required by the circumstances, said composition can comprise a polymer different from the polymer (PA) of the present invention.

Said polymer is preferably selected in the group comprising: aliphatic or semi-aromatic polyamides, polyester polymer, polyarylether sulfone polymer, polyaryl ether ketone polymer, polyarylene sulfide polymer, polyarylene ether polymer, liquid crystal polymer and combinations thereof.

Preferably, said composition (C) comprises from 10 to 99.9 wt. % of the polymer (PA) of the invention, more preferably from 20 to 90 wt. %, and even more preferably from 25 to 85 wt. %, based on the total weight of the composition (C).

Preferably, said composition is manufactured by contacting said polymer (PA), with the other additional ingredient(s), and processing them to the melting temperature of the polymer (PA).

Said composition can be prepared by hot mixing the above mentioned ingredients at a temperature allowing to keep polymer (PA) in the molten state. Alternatively, said composition can be prepared by cold mixing.

Typically, after mixing, said composition (C) is further processed via an extruder, in to provide pellets.

Shaped articles can be advantageously manufactured using said composition

(C) or said pellets, via moulding, including for example injection moulding, blow moulding, water moulding; extrusion; pelletizing.

Any type of shaped article can be manufactured using either the polymer (PA) or the composition (C) according to the present invention.

Advantageously, the shaped article obtained using the polymer (PA) of the invention shows biodegradability properties.

The present invention will be now explained in more detail by reference to the following examples, which are intended to represent the invention without limiting it.

### Experimental Section

Materials:

4-piperidinecarboxlic acid (also referred to as ‘hexahydroisonicotinic acid’, ‘isonipecotic acid’ and with the acronym ‘INP’) (CAS 498-94-2) was obtained from Sigma-Aldrich.

1,6-hexamethylenediamine; 1,10-decanediamine; 1,12-dodecanediamine; adipic acid; isophthalic acid; terephthalic acid were obtained from Sigma-Aldrich.

A 60/40 blend of 1,9-nonanediamine (NMDA) and 2-methyl-octanediamine (MODA) was obtained from Kuraray Co., Ltd.

m-Xylenediamine (MXD) was obtained from Mitsubishi Gas Chemical.

Polyamide PArA® 0000 resin, homopolymer of MXD and adipic acid, was obtained by Solvay Specialty Polymers USA, LLC.

Selar® PA 3426 resin was obtained from E I Du Pont de Nemours Chemical Company.

Hexafluoroisopropanol (HFIP) was obtained from Oakwood Chemical, sodium trifluoroacetate (NaFTA) from Acros Organics.

Miracle-Grog Performance Organics™ All Purpose In Ground Soil, a mixture of compost and soil of pH 6.0 to 6.5, was obtained at Home Depot.

Methods:

Thermogravimetric analysis (TGA) was conducted under nitrogen according to the ASTM E2550.

Differential scanning calorimetry (DSC) analysis was conducted using a heating and cooling rate of 20° C./min according to the ASTM D3418. Glass transition and melting temperatures were determined from the second heat ramp results.

Gel permeation chromatography (GPC) was performed following an internal method, employing a WatersModular SEC Instrument, a Waters Alliance 2695 Separation Module, a Waters 2487 Dual Absorbance Detector, a Waters 2414 Refractive Index Detector, a Waters 515 pump and Waters Empower Pro Gel Chromatography Software. The instrument was equipped with two PL gel 10 μm MiniMixe B 250×4.6 mm columns and a guard column The samples were dissolved at 5 to 6 g/L in HFIP containing 0.05 M NaFTA; a 15 μl sample was injected. Elution was conducted as 40° C. Results were calibrated against a broad MW internal standard, AMODEL® 1000, M_{w}=27943, Mₙ=9340, M_{w}Mₙ=2.99.

### Comparative Example 1C(*): INP Homo-Polyamide

A 25 g reactor was charged with 29.0 g (225 mmol) isopinecotic acid, 12 g water and 19.9 mg (0.242 mmol) phosphorous acid.

The reactor was heated to a temperature of 238° C. and a pressure of 300 psig (2.068 MPa). Pressure was controlled at 300 to 280 psig (2.068 to 1.931 MPa) by venting of steam and temperature was increased to 282° C. over a period of 30 minutes. Pressure was lowered to atmospheric over a span of 30 minutes as temperature was increased to 288° C. A nitrogen sweep was conducted for 15 minutes. After cooling, the product was removed as a solid plug.

The polymer was produced as a porous, crumbly cream-colored solid. A minor amount of sublimed monomer was present on the interior surface of the reactor head.

Thermogravimetric analysis under nitrogen showed a 3.8% loss of moisture below 200° C. and an onset of degradation at 451° C.

Thermal and molecular weight properties were evaluated and the results are reported in Table 1 below.

### Example 2

A 25 g reactor was charged with 2.27 g (17.6 mmol) isopinecotic acid, 4.02 g (34.6 mmol) 1,6-hexamethylenediamine, 5.43 g (32.7 mmol) terephthalic acid, 5 g water and 7.94 mg (0.0974 mmol) phosphorous acid.

The reactor was heated to a temperature of 279° C. and a pressure of 375 psig (2.586 MPa). Pressure was controlled at 375 to 420 psig (2.586 to 2.896 MPa) by venting of steam and temperature was increased to 288° C. over a period of 20 minutes. Pressure was lowered to atmospheric over a span of 35 minutes as temperature was increased to 297° C. This temperature was maintained and a steam finish was applied for 35 minutes.

### Examples 3 to 7

Polyamides of Examples 3 through 7 were prepared following the procedure described above, and using the monomers in the amounts described in Table 1 below.

Thermal and molecular weight properties were evaluated for each co-polyamide and the results are reported in Table 1 below.

### Comparative Example 8C(*)

Comparative example 8C(*) was commercial resin Selar® PA 3426, 100% 6I/6T

Thermal and molecular weight properties were evaluated and the results are reported in Table 1 below.

### Comparative Example 9C(*)

A 25 g reactor was charged with 3.61 g (28.0 mmol) isopinecotic acid, 3.41 g (29.4 mmol) 1,6-hexamethylenediamine, 4.65 g (28.0 mmol) isophthalic acid, 5 g water and 7.94 mg (0.097 mmol) phosphorous acid.

The reactor was heated to a temperature of 240° C. and a pressure of 420 psig (2.896 MPa). Pressure was maintained above 350 psig (2.413 MPa) and temperature increased to 277° C. over a period of 35 minutes. Pressure was lowered to atmospheric over a span of 30 minutes as temperature was increased to 284° C. This temperature was maintained and a steam finish was applied for 30 minutes.

TABLE 1

| | 1C(*) | 2 | 3 | 4 | 5 | 6 | 7 | 8C(*) | 9C(*) |
|---|---|---|---|---|---|---|---|---|---|
| INP | 100 | 22 | 14 | 14 | 25 | 25 | 25 | | 50 |
| Hexamethylen | — | 39 | — | — | 37.5 | 37.5 | | 50 | 25 |
| diamine | | | | | | | | | |
| 1,9-nonane | — | — | — | — | — | — | 22.5 | — | — |
| diamine | | | | | | | | | |
| 2-methyloctane | — | — | — | — | — | — | 15.0 | — | — |
| diamine | | | | | | | | | |
| 1,10- | — | — | 43 | — | — | — | — | — | — |
| decamethylendiamine | | | | | | | | | |
| 1,12- | — | — | — | 43 | — | — | — | — | — |
| dodecamehylendiamine | | | | | | | | | |
| Terephthalic acid | — | 39 | 43 | 43 | 37.5 | — | 37.5 | 25 | — |
| Isophthalic acid | — | — | — | — | — | 37.5 | | 25 | 25 |

Thermal properties and polydispersity (PD)

| | | | | | | | | | |
|---|---|---|---|---|---|---|---|---|---|
| Tg (° C.) | >400 | 152 | 124 | 114 | 143 | 139 | 135 | 125 | 135 |
| Tm (° C.) | >400 | 311 | 277 | 258 | 298 | — | — | | — |
| Mₙ | 4300 | 10000 | 10800 | 15100 | 12700 | 11200 | 13000 | 12800 | 2490 |
| M_{w} | 5900 | 34200 | 45400 | 33300 | 28500 | 20000 | 30000 | 33000 | 4770 |
| PD (M_{w}/Mₙ) | 1.38 | 3.42 | 4.22 | 2.20 | 2.25 | 1.77 | 2.31 | 2.58 | 1.92 |

(*)comparison

The above results showed that the polyamides according to the present invention had excellent balance of Tg and Tm, together with good molecular weight and narrow PD. The results reported in Table 1 showed that the polyamide according to the present invention contributes to high conversion in polymerization when present at less than 50 mol. %.

Inventive Example 2 in which INP contributes to 22 mol. % of the amide linkages, exhibits high Tg and a Tm that allows a good processing window. In contrast, Comparative Example 9C, in which INP contributes to 50 mol. % of the amide linkages proceeded to a low conversion that is incompatible with good mechanical properties.

Metl Viscosity Test

The melt viscosity behaviour was evaluated for polyamides of Example 7 and Example 8C.

The Dynamic Mechanical Analysis (DMA) was performed using the procedure described below, in accordance with ASTM D4440-15.

Dried granules or pellets of the polymers were ground to powders using a Thomas Wiley Mini-Mill manufactured by Thomas Scientific. The powders were then dried for 4 hours at 110° C. Compression moulding was accomplished using a Greenard CPA-50 hydraulic press. A 25 mm diameter 5 mil hard bright aluminium foil disc was placed at the bottom of cylindrically shaped mould cavity with inner diameter 25 mm. A 1.0 gram sample of the powder was added and then a second foil disc. A pressure of 2400 psi was applied for 10 seconds to produce disks of 1.0 to 2.0 mm thickness. The disks were then stored in heat-sealed aluminium foil envelopes until testing.

Foil layers were removed and samples were placed between parallel plates of a TA Ares G-2 Rheometer. A strain of 1% was applied and a frequency sweep from 1 to 100 rad/s was conducted at multiple temperatures for each sample.

Example 7 was evaluated at 210, 220, 230, 240 and 250° C.

Example 8C was evaluated at 175, 215, 245, 275, and 290° C.

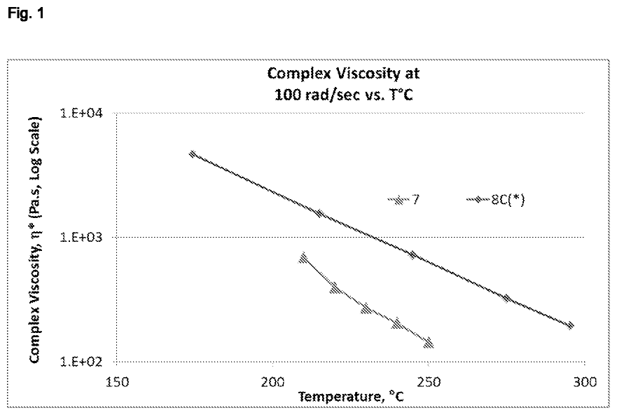

The results are provided in FIG. 1, wherein the marked higher flow at equal temperature for Example 7 compared to Example 8C at 100 rad/s was shown.

Table 2 below shows data for Example 7 and Comparative Example 8C, at comparable T-Tg, where clearly η* is three to two times higher for example 8C compared to 7.

TABLE 2

| Angular frequency | T | T − Tg | η* | |
|---|---|---|---|---|
| rad/s | (° C.) | (° C.) | (Pa · s) | Example |
| 1 | 210 | 85 | 1142 | 7 |
| 10 | 210 | 85 | 898 | |
| 100 | 210 | 85 | 690 | |
| 1 | 215 | 90 | 3645 | 8C(*) |
| 10 | 215 | 90 | 3182 | |
| 100 | 215 | 90 | 1553 | |

(*)comparison

The polyamides of the invention exhibited good polydispersity and, as shown in FIG. 1 and Table 2, surprisingly lower melt viscosity than expected based upon comparison with polyamides that are similar in molecular weight and in Tg and do not contain INP. As a consequence, the polyamides according to the present invention exhibit excellent processing in injection molding, extrusion, thermoplastic composite fabrication and other melt processes including some types of additive manufacturing.

Biodegradability Test

A study of the biodegradability of one polyamide according to the present invention was conducted following the methods described by Koichiro Tachibana, K. H., Masato Yoshikawa, Haruki Okawa (2010) “Isolation and characterization of microorganisms degrading nylon 4 in the composted soil.” Polymer Degradation and Stability 95(6): 912-917.

Example 10 was prepared following the procedure applied to Examples 3 to 7 described above, using the monomers as described in Table 3 below.

Comparative Example 11C (MXD,6) was is a commercial ingredient for IXEF® polyamide compounds.

TABLE 3

| | Example 10 | Example 11C(*) |
|---|---|---|
| INP (mol %) | 18 | — |
| m-Xylylenediamine (mol %) | 41 | 50 |
| Adipic acid (mol %) | 41 | 50 |

Thermal and MW Properties

| | | |
|---|---|---|
| Tg (° C.) | 98 | 90 |
| Tm (° C.) | — | 238 |
| Mₙ | 15500 | 23000 |
| M_{w} | 31700 | 49700 |
| PD (M_{w}/Mₙ) | 2.05 | 2.17 |

Exposure to Soil and Compost Blend

| | | |
|---|---|---|
| 21-day weight increase | 16% | 8% |
| 21-day appearance of surface pitting | Yes | No |
| and internal voids | | |

(*)comparison

Samples were prepared for the Soil Burial Degradation test as follows.

Dried polymer powder was prepared as described earlier for DMA testing. Compression molding was accomplished using a Carver hydraulic press. A 5 mil aluminum sheet was placed Into the bottom of a 4″×4″ mold, followed by placement of four 0.5 mm shims in each corner. A 10-g powder was evenly spread over the bottom aluminum and a second piece of foil was placed on top. The mold was placed onto the Carver Press which was pre-heated at 240° C. and the heat/pressure cycle was initiated. The programmed cycle was as follows: 1000 psi (6.895 MPa) for a duration of 3 minutes. 3000 psi (20.684 MPa) for 5 minutes. 1500 psi (10.342 MPa) for 3 minutes. Cool from 240° C. to 50° C. Once cooled, the mold was disassembled and the aluminum sheets removed from the top and bottom of the polymer film. The films produced were homogenous and of good quality. The film thickness ranged from 0.38 to 0.5 mm.

The films were broken into four films (about 1″×1″-2.54 cm×2.54 cm) and placed into a large container containing Miracle-Grog Performance Organics™ All Purpose In Ground Soil, a blend of soil and compost. The soil was kept moist by occasionally spraying deionized water onto it.

The samples were also subjected to a heater set at 80° F. (26.6° C.) during the day and cooled to −70° F. (31.1° C.) overnight. Readings of 50 to 90% humidity were observed. After 3 weeks of submersion, one film of each buried composition was dug up. The samples were rinsed with ethanol and weighed.

Analysis and observation via optical and SEM microscopy showed a markedly different effect of soil and compost exposure on Example 10 in comparison to Example 110. In particular, the surface of film obtained with Example 10 became rough and stained with adhered soil component and the surface was marked by pits of up to 60 microns in diameter. On the contrary, the surface of the film obtained with Example 110 was smooth and featureless and identical to the surface before exposure.

The observation via optical and SEM microscopy confirmed that the film obtained with the INP-containing polyamides of the invention undergo the enzymatic degradation effect.

Should the disclosure of any patents, patent applications, and publications which are incorporated herein by reference conflict with the description of the present application to the extent that it may render a term unclear, the present description shall take precedence.

1. A polymer [polymer (PA)] comprising:
less than 50 mol. % relative to the total number of moles of recurring units in polymer (PA) of recurring units comprising a piperidine ring and complying with formula [R_{INP}]: 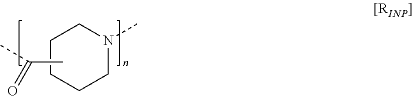
at least one recurring unit [R_{PA}] selected from:
[R_{PA}(I)]—[R_{PA}(II)] [symbol] [HN-G^{I}-NH]—[(O═)C-G^{II}-C(═O)] [symbol]
[R_{PA}(III)] [symbol] [HN-G^{III}-C(═O)] [symbol]
wherein:
each of G^{I}, G^{II} and G^{III} is an optionally substituted linear or branched alkyl chain comprising from 1 to 16 carbon atoms, an optionally substituted cycloalkyl group comprising 6 carbon atoms, or an optionally substituted phenylene; wherein said recurring units [R_{INP}] and [R_{PA}] are randomly disposed along the backbone of said polymer (PA) and the sum of the number of moles of recurring units [R_{INP}] and [R_{PA}] is 100%.

2. The polymer (PA) according to claim 1, wherein said —C(═O)— group is in position 3 or in position 4 of said piperidine ring in formula [R_{INP}].

3. The polymer (PA) according to claim 1, said polymer (PA) comprising up to 49 mol. % and at least 0.5 mol. % of said recurring units the amount being relative to the total number of moles of recurring units in the polymer (PA).

4. The polymer (PA) according to claim 3, said polymer (PA) comprising from 2 to 45 mol. % of said recurring units the amount being relative to the total number of moles of recurring units in the polymer (PA).

5. The polymer (PA) according to claim 1, said polymer (PA) comprising at least 51 mol. % of said at least one recurring unit [R_{PA}], and up to 99.5 mol. % of said at least one recurring unit [R_{PA}], the amount being relative to the total number of moles of recurring units in the polymer (PA).

6. The polymer (PA) according to claim 5, said polymer (PA) comprising from 55 to 98 mol. % of said at least one recurring unit [R_{PA}], the amount being relative to the total number of moles of recurring units in the polymer (PA).

7. The polymer (PA) according to claim 1, wherein said recurring unit [R_{PA}] complies with formula
[R_{PA}(I)]—[R_{PA}(II)] [symbol] [HN-G^{I}-NH]—(O═)C-G^{II}-C(═O)] [symbol]
wherein said
[R_{PA}(I)] [symbol] [HN-G^{I}-NH]—* and
[R_{PA}(II)]*[(O═)C-G^{II}-C(═O)] [symbol]
are in a substantially equimolar amount,
with * indicating the bond between the nitrogen atom of [R_{PA}(I)] and the carbon atom of [R_{PA}(II)].

8. The polymer (PA) according to claim 7, wherein said [R_{PA}(I)] is selected from the group comprising at least one divalent moiety complying with any of the following formulae, wherein * indicates the bond between the nitrogen atom of [R_{PA}(I)] and the carbon atom of [R_{PA}(II)]: 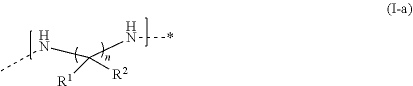
wherein
n is an integer from 1 to 20,
R¹ and R² are independently selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium; 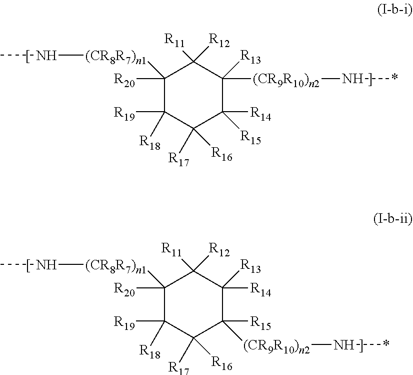
wherein
each of R₇ to R₂₀ is independently selected from hydrogen atom, halogen atom, alkyl, alkenyl, alkynyl, aryl, cycloalkyl, cycloaryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,
each of n1 and n2, independently, is 0 or an integer from 1 to 20; 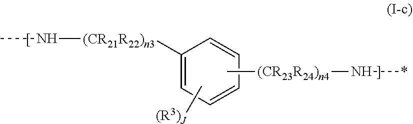
wherein
R³ is selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium,
J is 0 or an integer from 1 to 4,
each of R₂₁ to R₂₄ is independently selected from hydrogen atom, halogen atom, alkyl, alkenyl, alkynyl, aryl, cycloalkyl, cycloaryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,
each of n3 and n4, independently, is 0 or an integer from 1 to 20;
(I-d) [symbol]
{NH—(CR₂₅R₂₆CR₂₇R₂₈)ₙ₅—[(CR₂₉R₃₀CR₃₁R₃₂O)ₙ₆]ₘ₁—(CR₃₃R₃₄CR₃₅R₃₆)ₙ₇—NH} [symbol]
wherein *
each of R₂₅ to R₃₆ is independently selected from hydrogen atom or alkyl chain having from 1 to 3 carbon atoms,
each of n5, n6, m1 and n7 is independently 0 or an integer from 1 to 12, and the recurring units having n5, n6, m1 and n7 are randomly disposed; 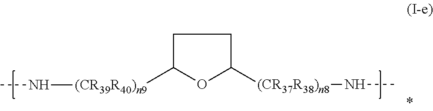
wherein
each of R₃₇ to R₄₀ is independently selected from hydrogen atom or alkyl chain having from 1 to 3 carbon atoms,
each of n8 and n9 is independently 0 or an integer from 1 to 12;
and said [R_{PA}(II)] is selected from the group comprising at least one divalent moiety complying with any of the following formulae: 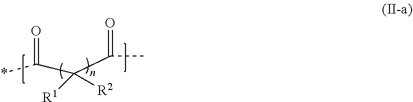
wherein
n, R¹ and R² have the meanings defined for formula (I-a); 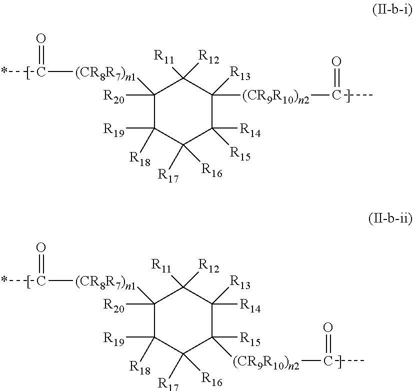
wherein
each of R₇ to R₂₀, n1 and n2 has the meanings defined for formulae (I-b-i) and (I-b-ii); 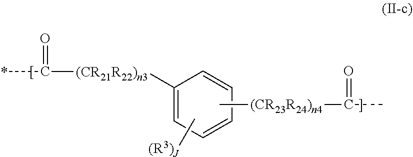
wherein
each of R³, J, n3, n4 and R₂₁ to R₂₄ has the meanings defined for formula (I-c); 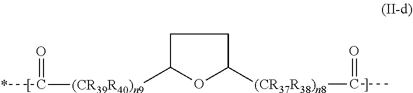
wherein each of R₃₇ to R₄₀, n8 and n9 has the meanings defined for formula (I-e).

9. The polymer (PA) according to claim 1, wherein said at least one recurring unit of formula [R_{PA}(III)] is selected from the group comprising at least one divalent moiety complying with the following formulae: 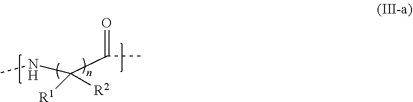
wherein
n is an integer from 1 to 20
R¹ and R² are independently selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium; 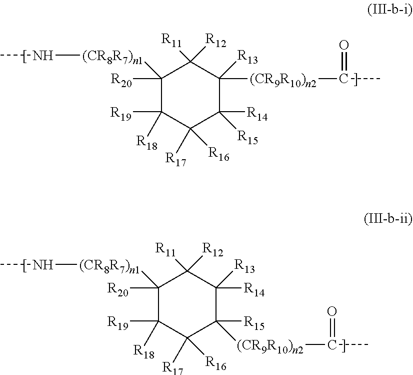
wherein
each of R₇ to R₂₀ is independently selected from hydrogen atom, halogen atom, alkyl, alkenyl, alkynyl, aryl, cycloalkyl, cycloaryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,
each of n1 and n2, independently, is 0 or an integer from 1 to 20; 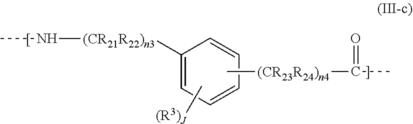
wherein
R³ is selected from hydrogen atom, halogen atom, alkyl, alkenyl, ether, thioether, ester, amide, imide, alkali or alkaline earth metal sulfonate, alkyl sulfonate, alkali or alkaline earth metal phosphonate, alkyl phosphonate, amine, quaternary ammonium,
J is 0 or an integer from 1 to 4,
each of R₂₁ to R₂₄ is independently selected from hydrogen atom, halogen atom, alkyl, alkenyl, alkynyl, aryl, cycloalkyl, cycloaryl, ether, thioether, carboxylic acid, ester, amide, imide, alkali or alkali or alkaline earth metal sulfonate, alkyl sulfonate, alkali or alkaline earth metal phosphonate, alkyl phosphonate, amine, quaternary ammonium,
each of n3 and n4, independently, is 0 or an integer from 1 to 20.

10. A composition [composition (C)] comprising polymer (PA) according to claim 1, in admixture with at least one additional ingredient selected from reinforcing fibres and additives.

11. The composition (C) according to claim 10, wherein said reinforcing fibers are selected in the group consisting of carbon fibers, continuous or chopped glass fibers, synthetic polymeric fibres, aluminium fibres, aluminium silicate fibres, titanium fibres, steel fibres, silicon carbide fibres and boron fibers; and/or said additives are selected from the group consisting of: UV stabilizers, heat stabilizers, pigments, dyes, flame retardants, impact modifiers, processing aids, nucleating agents, mineral fillers, and mixtures thereof.

12. The composition (C) according to claim 10, said composition comprising from 10 to 99.9 wt. % of the polymer (PA), based on the total weight of the composition (C).

13. An article comprising polymer (PA) according to claim 1 or a composition (C) comprising the polymer (PA) and at least one additional ingredient selected from reinforcing fibres and additives.

14. A thermoplastic composite comprising polymer (PA) according to claim 1 and continuous and/or non-continuous fibres.

15. The thermoplastic composite according to claim 14, wherein said fibres are glass fibres or carbon fibers.

16. The polymer (PA) according to claim 3, said polymer (PA) comprising from 10 to 30 mol. % of said recurring units [R_{INP}], the amount being relative to the total number of moles of recurring units in the polymer (PA).

17. The polymer (PA) according to claim 5, said polymer (PA) comprising from 70 to 90 mol. % of said at least one recurring unit [R_{PA}], the amount being relative to the total number of moles of recurring units in the polymer (PA).
